(19) United States
(12) Patent Application Publication
(10) Pub. No.: US 2021/0394491 A1
(43) Pub. Date: Dec. 23, 2021

(54) LAMINATED GLASS FOR VEHICLE

(71) Applicants: Showa Denko Materials Co., Ltd., Chiyoda-ku, Tokyo (JP); TOYOTA JIDOSHA KABUSHIKI KAISHA, Toyota-shi, Aichi (JP)

(72) Inventors: Reimi EMOTO, Nagoya-shi, Aichi (JP); Tomohiro MIWA, Toyota-shi, Aichi (JP); Tomohiro ARAKI, Toyota-shi, Aichi (JP); Kyosuke NAKAMURA, Toyota-shi, Aichi (JP); Naoki TAKAHARA, Chiyoda-ku, Tokyo (JP); Akihiro YOSHIDA, Chiyoda-ku, Tokyo (JP); Eisaku ISHIKAWA, Chiyoda-ku, Tokyo (JP); Hiroki KUZUOKA, Chiyoda-ku, Tokyo (JP); Ryoh TAKAHASHI, Chiyoda-ku, Tokyo (JP); Keiichiro NISHIMURA, Chiyoda-ku, Tokyo (JP); Yukiko INOUE, Chiyoda-ku, Tokyo (JP); Miku KAWAMURA, Chiyoda-ku, Tokyo (JP)

(21) Appl. No.: 17/297,457

(22) PCT Filed: Nov. 27, 2019
(86) PCT No.: PCT/JP2019/046442

§ 371 Date: May 27, 2021

(30) Foreign Application Priority Data
Nov. 30, 2018 (JP) 2018-225821

(51) Int. Cl. B32B 17/10; B32B 7/022

(52) U.S. Cl. CPC B32B 17/10605; B32B 17/10036; B32B 7/022; B60J 1/00; B32B 2307/56; B32B 2307/732; B32B 2605/006

(57) ABSTRACT

A laminated glass including two facing glass plates and an interlayer film disposed between the two glass plates. The interlayer film has a resin layer having a storage modulus of 1000 MPa or more at a temperature of 25° C. and a frequency of 1×10⁵ Hz. The laminated glass may be a windshield for an automobile.

### TECHNICAL FIELD

The present invention relates to a laminated glass for a vehicle.

### BACKGROUND ART

Conventionally, as glass for vehicles such as automobiles, aircrafts, buildings, and the like, a laminated glass in which few glass fragments are scattered when broken has been widely used. The laminated glass has generally an interlayer film interposed between two glass plates. As the interlayer film for a laminated glass, for example, resin layers containing a polyvinyl acetal resin, an ionomer resin, an acrylic resin, and the like are used (for example, Patent Literatures 1 to 5).

### CITATION LIST

### Patent Literature

Patent Literature 1: Japanese Unexamined Patent Publication No. 2016-193542
Patent Literature 2: Japanese Unexamined Patent Publication No. 2009-298046
Patent Literature 3: Japanese Unexamined Patent Publication No. 2015-151540
Patent Literature 4: Japanese Examined Patent Publication No. S62-028105
Patent Literature 5: Japanese Unexamined Patent Publication No. 2000-001345

### SUMMARY OF INVENTION

### Technical Problem

A glass member such as a windshield used for automobiles is required to be excellent in resistance to collision of scattered matters such as flying stones during traveling, that is, chipping resistance. On the other hand, in order to reduce the glass member in weight, a glass plate is desired to be as thin as possible. However, when the glass plate is thin, there is a tendency that it becomes difficult to maintain sufficient chipping resistance.

In this regard, an object of an aspect of the present invention is to achieve further improvement in chipping resistance of a laminated glass.

### Solution to Problem

An aspect of the present invention relates to a laminated glass for a vehicle, including two facing glass plates and an interlayer film disposed between these two glass plates. The interlayer film has a resin layer having a storage modulus of 1000 MPa or more at a temperature of 25° C. and a frequency of 1×10⁵ Hz.

According to the findings of the present inventors, the storage modulus of the resin layer at a temperature of 25° C. and a frequency of 1×10⁵ Hz correlates with the chipping resistance of the laminated glass. At the moment when a flying stone collides against the laminated glass, a tensile stress occurs at the inside of the glass plate outside the laminated glass. This tensile stress is considered to be a main cause of breaking of the laminated glass. According to the simulation conducted by the present inventors, the tensile stress by collision occurs at a timescale corresponding to the vicinity of a frequency of 1×10⁵ Hz. Therefore, it is considered that a large storage modulus of the resin layer at a frequency of 1×10⁵ Hz contributes to improvement in chipping resistance.

### Advantageous Effects of Invention

According to an aspect of the present disclosure, a laminated glass with further improved chipping resistance is provided.

### BRIEF DESCRIPTION OF DRAWINGS

FIG. 1 is a cross-sectional view illustrating an embodiment of a laminated glass.

FIG. 2 shows an example of master curves obtained by dynamic viscoelasticity measurement.

FIG. 3 is a cross-sectional view illustrating an embodiment of a film material for an interlayer film of the laminated glass.

### DESCRIPTION OF EMBODIMENTS

Hereinafter, several embodiments of the present disclosure will be described in detail. However, the present disclosure is not limited to the following embodiments.

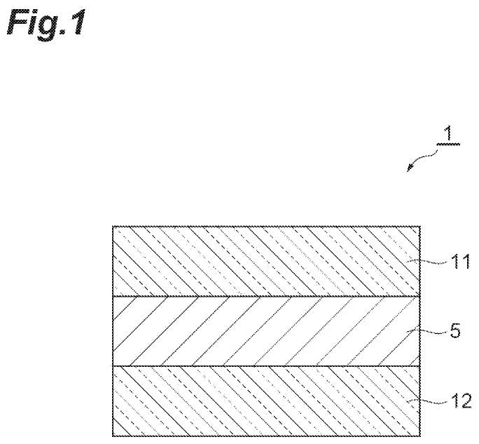

FIG. 1 is a cross-sectional view illustrating an embodiment of a laminated glass. A laminated glass 1 illustrated in FIG. 1 includes two facing glass plates 11 and 12 and an interlayer film 5 disposed therebetween.

The glass plates 11 and 12 may be, for example, inorganic glass plates such as float glass, air-quenched tempered glass, chemically tempered glass, and multilayer glass. One or both of the glass plates 11 and 12 may be a transparent substrate made of a resin. Examples of the transparent substrate include transparent plastic substrates such as an acrylic resin substrate, a polycarbonate substrate, a cycloolefin polymer substrate, and a polyester substrate.

The thickness of one glass plate 11 may be larger than the thickness of the other glass plate 12. When the laminated glass is used as a glass member of a vehicle (for example, a windshield for an automobile), the laminated glass 1 is typically mounted on the vehicle in a direction of the thicker glass plate 11 being positioned outside the vehicle. The ratio of the thickness of the glass plate 11 to the thickness of the glass plate 12 may be, for example, 1.1 to 3.0. However, the thicknesses of the two glass plates may be the same. The thicknesses of the glass plates 11 and 12 may be, for example, 0.1 mm or more, or 0.5 mm or 0.8 mm or more. The thickness of the glass plate 11 may be 0.1 mm or more, or 0.5 mm or 0.8 mm or more and 30 mm or less, and may be 0.1 mm or more, or 0.5 mm or 0.8 mm or more and 20 mm or less. The thickness of the glass plate 12 may be 0.1 mm or more, or 0.5 mm or 0.8 mm or more and 20 mm or less, and may be 0.1 mm or more, or 0.5 mm or 0.8 mm or more and 15 mm or less.

The interlayer film 5 has one or more resin layers (hereinafter, referred to as the “chipping-resistant layer” in some cases) having a storage modulus of 1000 MPa or more at a temperature of 25° C. and a frequency of 1×10⁵ Hz. The interlayer film 5 may be a single-layered chipping-resistant layer and may further have a resin layer other than the chipping-resistant layer.

From the viewpoint of further improving chipping resistance, the storage modulus of the chipping-resistant layer at a temperature of 25° C. and a frequency of 1×10⁵ Hz may be 1200 MPa or more and 7000 MPa or less, or 6500 MPa or less, may be 1300 MPa or more and 7000 MPa or less, or 6500 MPa or less, and may be 1400 MPa or more and 7000 MPa or less, or 6500 MPa or less.

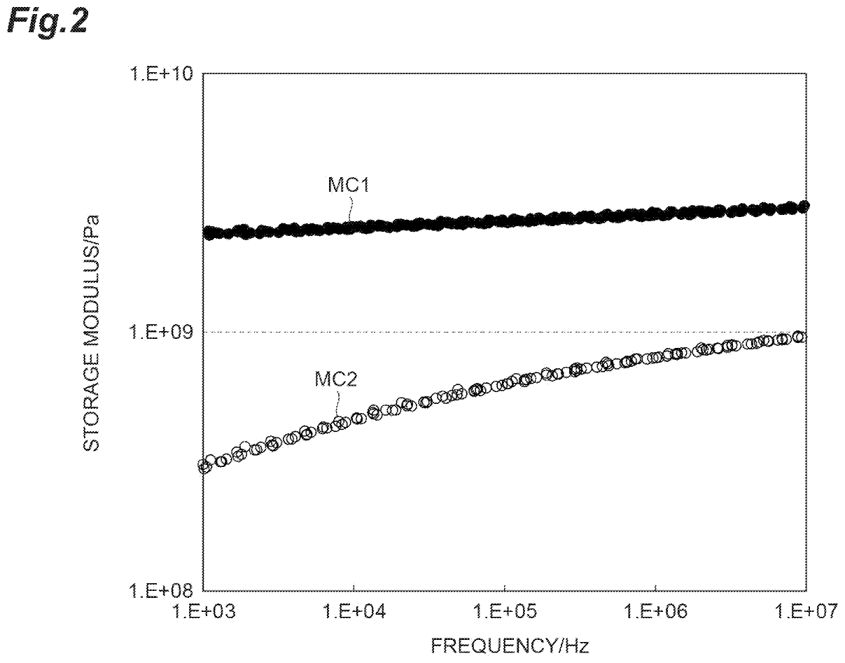

The storage modulus at a temperature of 25° C. and a frequency of 1×10⁵ Hz can be obtained from a master curve at a reference temperature of 25° C. which is prepared by dynamic viscoelasticity measurement and time-temperature superposition principle. The dynamic viscoelasticity measurement is performed, for example, according to the method based on JIS K 0129:2005 under conditions of a temperature of −30° C. to 25° C., a frequency of 0.5 Hz to 50 Hz and a strain amount of 0.05% at a tensile measurement mode. From the viscoelasticity measurement results, a master curve showing a relation between a storage modulus and a frequency is prepared by the WLF method while a reference temperature is set to 25° C., and from this master curve, the storage modulus at a frequency of 1×10⁵ Hz can be read. FIG. 2 shows an example of master curves obtained by dynamic viscoelasticity measurement. Master curves MC1 and MC2 shown in FIG. 2 are obtained by the WLF method while a reference temperature is set to 25° C. At a frequency of 1×10⁵ Hz, the master curve MC1 shows a storage modulus of 1000 MPa or more, and the master curve MC2 shows a storage modulus of less than 1000 MPa.

When the interlayer film 5 is configured by a plurality of resin layers, the resin layer disposed at a position adjacent to the thicker glass plate 11 may be a chipping-resistant layer. Thereby, when the laminated glass 1 is mounted on the vehicle in a direction of the glass plate 11 being positioned outside the vehicle, the effect of improving chipping resistance to scattered matters colliding from the outside is particularly effectively exhibited.

The thickness of the chipping-resistant layer constituting the interlayer film 5 may be 0.001 to 10 mm or 0.01 to 1 mm, from the viewpoint of improving chipping resistance, or the like.

The chipping-resistant layer constituting the interlayer film 5 contains, for example, a thermoplastic resin. The chipping-resistant layer may further contain a plasticizer. The storage modulus of the resin layer can be controlled, for example, by the type of the thermoplastic resin and the content of the plasticizer. As the ratio of the amount of the plasticizer to the amount of the thermoplastic resin is increased, generally, there is a tendency that the storage modulus at a temperature of 25° C. and a frequency of 1×10⁵ Hz is decreased.

The thermoplastic resin constituting the chipping-resistant layer may contain, for example, at least one selected from a polyvinyl butyral resin, an acrylic resin (acrylic polymer), an ethylene-vinyl acetate copolymer resin, an ethylene-acrylic acid copolymer resin, a polyurethane resin, and a polyvinyl alcohol resin, and the chipping-resistant layer may contain a polyvinyl butyral resin as the thermoplastic resin. In this case, the ratio of the polyvinyl butyral resin to the total amount of the polyvinyl butyral resin and other thermoplastic resin may exceed 85% by mass, and may be 90% by mass or more or 95% by mass or more.

The content of the plasticizer in the chipping-resistant layer may be 0 to 18% by mass on the basis of the amount of the thermoplastic resin, or particularly, the amount of the polyvinyl butyral resin. When the content of the plasticizer is 18% by mass or less, the chipping resistance of the laminated glass may be significantly improved. From the same viewpoint, the content of the plasticizer may be 17% by mass or less, 16% by mass or less, 15% by mass or less, 14% by mass or less, 13% by mass or less, 12% by mass or less, 11% by mass or less, 10% by mass or less, 9% by mass or less, 8% by mass or less, 7% by mass or less, 6% by mass or less, or 5% by mass or less, and may be 0% by mass or more, on the basis of the amount of the polyvinyl butyral resin.

Since the plasticizer is generally used as a plasticizer for a thermoplastic resin, the plasticizer can be selected without particular limitation. For example, the plasticizer may contain a fatty acid ester compound, an organophosphate ester compound, or a combination thereof.

The aliphatic ester compound may be, for example, a monoester or diester of polyalkylene glycol and aliphatic monocarboxylic acid. Examples of the polyalkylene glycol include triethylene glycol, tetraethylene glycol, and tripropylene glycol. Examples of the aliphatic monocarboxylic acid include butyric acid, isobutyric acid, caproic acid, 2-ethylbutyric acid, hepthylic acid, n-octylic acid, 2-ethylhexylic acid, n-nonylic acid, and decylic acid. The aliphatic ester compound may be an ester of a linear or branched alkyl alcohol having 4 to 8 carbon atoms and aliphatic polycarboxylic acid. Examples of the aliphatic polycarboxylic acid include adipic acid, sebacic acid, and azelaic acid.

The plasticizer may contain, for example, at least one aliphatic ester compound selected from triethylene glycol mono(2-ethylhexanoate), triethylene glycol di(2-ethylhexanoate), triethylene glycol di-2-ethylbutyrate, and triethylene glycol di(2-ethylpropanoate).

Examples of the organophosphate ester compound include tributoxyethyl phosphate, isodecyl phenyl phosphate, and triisopropyl phosphate.

The chipping-resistant layer can contain other components as necessary. Examples of the other components include an antioxidant and an inorganic filler. The ratio of the total amount of the polyvinyl butyral resin and the plasticizer in the chipping-resistant layer may be 80% by mass or more or 90% by mass or more, on the basis of the amount of the chipping-resistant layer or the resin material for forming the chipping-resistant layer.

Method for Producing Laminated Glass

The laminated glass 1 can be produced, for example, by a method including a step of forming a laminate having two facing glass plates 11 and 12 and an interlayer film disposed between these glass plates 11 and 12 and a step of heating and pressurizing the laminate to form the laminated glass 1.

The laminate having the glass plates and the interlayer film can be obtained, for example, by a method including pasting the interlayer film 5 to one glass plate 11 and pasting the other glass plate 12 to the interlayer film 5.

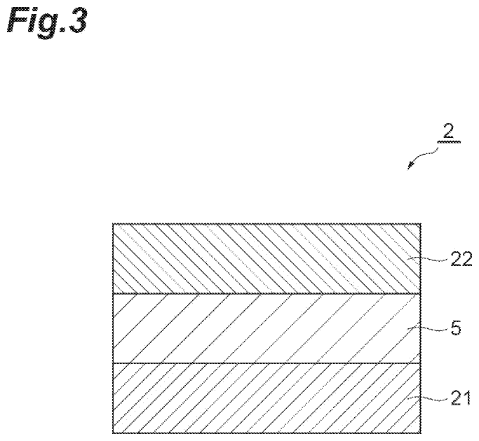

In order to form a laminate, for example, a film material having a resin layer constituting the interlayer may be used. FIG. 3 is a cross-sectional view illustrating an embodiment of a film material for an interlayer film of the laminated glass. A film material 2 illustrated in FIG. 3 includes the interlayer film 5 and two base films 21 and 22 covering both surfaces of the interlayer film 5. For example, the base film 21 may be peeled off from the film material 2, and the exposed interlayer film 5 may be pasted to the glass plate 11. One base film 21 may be a film having a light release surface as compared to the surface of the other base film 22. One or both of the base film 21 and the base film 22 may not be provided.

Examples of the base films 21 and 22 include a polyethylene terephthalate film, a polypropylene film, and a polyethylene film. For example, the thicknesses of the base films 21 and 22 are not particularly limited, and may be, for example, 25 to 200 μm.

The interlayer film 5 can be formed, for example, by a method of press-molding a resin material for forming an interlayer film or a method of applying a coating liquid containing a resin material and a solvent to a base film or the like and then removing the solvent from the coating film.

Conditions for heating and pressurizing the laminate composed of the glass plate 11, the interlayer film 5, and the glass plate 12 in order to obtain a laminated glass are adjusted so that respective layers are in sufficiently close contact with each other. The heating and pressurizing conditions are set, for example, in ranges of a pressure of 0.8 to 10 MPa, a temperature of 60° C. to 200° C., and a pressurizing time of 10 to 120 minutes.

The laminated glass 1 is particularly effectively utilized as a laminated glass for a vehicle requiring chipping resistance. Examples of the laminated glass for a vehicle include a windshield for an automobile, a side glass for an automobile, a sunroof for an automobile, and a rear glass for an automobile.

### EXAMPLES

Hereinafter, the present invention will be described in more detail by means of Examples. However, the present invention is not limited to these Examples.

1. Resin Layer for Interlayer Film

### Example 1

A polyvinyl butyral (PVB) resin (Mowital B75H, manufactured by Kuraray Co., Ltd., acetal unit: 71 to 81% by mass, hydroxyl group unit: 18 to 21% by mass, vinyl acetate unit: 1 to 4% by mass) was press-molded by a press molding machine under conditions of 150° C. and 30 minutes to form a resin layer for an interlayer film having a thickness of 0.4 mm.

### Example 2

100 parts by mass of the same PVB resin as that of Example 1 and 10 parts by mass of triethylene glycol di(2-ethylhexanoate) (3GO) were mixed. The mixture was sufficiently melt-kneaded with a mixing roll to obtain a PVB resin composition as a resin material for an interlayer film. The obtained PVB resin composition was press-molded by a press molding machine under conditions of 150° C. and 30 minutes to form a resin layer for an interlayer film having a thickness of 0.4 mm.

### Example 3

A resin layer for an interlayer film having a thickness of 0.4 mm was obtained in the same manner as in Example 2, except that the amount of triethylene glycol di(2-ethylhexanoate) (3GO) was changed to 15 parts by mass.

### Comparative Example 1

A resin layer for an interlayer film having a thickness of 0.4 mm was obtained in the same manner as in Example 2, except that the amount of triethylene glycol di(2-ethylhexanoate) (3GO) was changed to 20 parts by mass.

### Comparative Example 2

A resin layer for an interlayer film having a thickness of 0.4 mm was obtained in the same manner as in Example 2, except that the amount of triethylene glycol di(2-ethylhexanoate) (3GO) was changed to 30 parts by mass.

### Comparative Example 3

A non-crosslinkable ethylene-vinyl acetate copolymer (EVA) (EV170, manufactured by DuPont-Mitsui Polychemicals Co., Ltd., vinyl acetate content: 33% by mass) was press-molded by a press molding machine under conditions of 150° C. and 30 minutes to form a resin layer for an interlayer film having a thickness of 0.4 mm.

2. Storage Modulus of Resin Layer for Interlayer Film

A strip-shaped specimen having a width of 5 mm and a length of 50 mm was cut out from each resin layer for an interlayer film. The thickness of the specimen was measured by Micrometer (manufactured by Mitutoyo Corporation, MDE-25MX). The dynamic viscoelasticity of this specimen was measured with a dynamic viscoelasticity analyzer (manufactured by TA Instruments, Inc., RSA-G2) under the following conditions. The distance between two jigs holding the specimen was set to 20 mm.

### Transducer

Measurement mode: Tensile
Axial Force: 100.0 g
Sensitivity: 10.0 g
Proportional force Mode: Constant
Auto strain adjustment mode: Enable
Strain adjust: 15.0%
Minimum strain: 0.01%
Maximum strain: 5.0%
Minimum force: 5.0%
Maximum force: 300 g
   Measurement conditions
Test Parameters, Start temperature: −30° C.
Soak time: 30 seconds
End temperature: 25° C.
Temperature step: 1° C.
Strain: 0.05%
Logarithmic sweep mode
Angular frequency: 0.5 Hz to 50.0 Hz
Points per decade: 3

From the measurement results, a master curve set at a reference temperature of 25° C. was prepared by the WLF method. The storage modulus at a temperature of 25° C. and a frequency of 1×10⁵ Hz was obtained from the obtained master curve. For preparation of the master curve, data analysis of “TTS Wizard” in Trios (V3.3.1.4246) was utilized. Conditions for data analysis are as follows.

TTS Options
Auto-shift y variable: All y variable
Y shift base: Temperature only
Auto-shift type: X only
Remove shift zone on end session: No

### TTS Set Reference Curve

Curve Temperature: 25.0° C.

### TTS Generate Master Curve

Generate at Reference temperature
Model: WLF

3. Production of Laminated Glass

Each resin layer for an interlayer film was cut into a size of length 150 mm and width 67 mm and stuck on a float glass having a length of 150 mm, a width of 67 mm, and a thickness of 1.6 mm such that four sides overlapped, and the entire product was pressurized by a roller. Float glass having a length of 150 mm, a width of 67 mm, and a thickness of 1.1 mm was pasted on the exposed resin layer such that four sides overlapped, and the entire product was pressurized by a roller. Thereby, a laminate of the float glass/the interlayer film/the float glass was obtained. The obtained laminate was heated for 25 minutes using a vacuum laminator set at 125° C. Subsequently, the laminate was heated and pressurized in an autoclave set at 150° C. under conditions of a pressure of 115 N/cm² MPa and 120 minutes to obtain a laminated glass having a configuration of the float glass (1.6 mm)/the glass interlayer film/the float glass (1.1 mm). Ten laminated glasses were produced using each interlayer film resin layer of Examples or Comparative Examples by the same operation.

4. Chipping Resistance of Laminated Glass

Pressure-sensitive adhesive tapes having a width of about 5 mm and a length of about 67 mm were stuck on both ends along the long side of the float glass having a thickness of 1.1 mm of the laminated glass. A synthetic rubber plate (CR90 degrees) having a thickness of 6 mm and a width of 10.0 mm was stuck on the pressure-sensitive adhesive tape. One iron plate having a thickness of 3 mm, a length of 150 mm, and a width of 67 mm was attached to two synthetic rubber plates stuck on both ends of the float glass with an instant adhesive. Thereby, a test subject for chipping resistance evaluation in which ends of the laminated glass were fixed to the iron plate through the synthetic rubber plate was obtained.

Crushed stones continuously discharged from an ejection pipe of a flying stone testing apparatus (manufactured by Suga Test Instruments Co., Ltd., JA400) were caused to randomly collide against the surface on the side of the float glass having a thickness of 1.6 mm of the laminated glass of the test subject. Test conditions are as follows.
Distance between collision pipe tip and test subject: 350 mm
Stone type: Basalt
Discharge speed of crushed stone: 70 km/h
Crushed stone amount: 240 per one laminated glass (average weight: 0.25±0.005 g)
Collision incident angle: 0° with respect to vertical line of surface of laminated glass
Test subject temperature: 23° C.±1° C.

After the test, the laminated glass was visually observed, and the number of collision scars in which linear cracks having a length of 0.5 mm or more were recognized was recorded as the number of origins. The breaking probability was calculated by the following formula from this result. Here, the number of crushed stones is 240.

Breaking probability (%)=(Number of origins/Number of crushed stones)×100

The breaking probability of five test subjects was measured by the same method and an average value of the measurement values was obtained. From the average value of the breaking probability, the chipping resistance of the laminated glass was evaluated on the basis of the following determination criteria. As for the chipping resistance of the laminated glass, “A” is most excellent, and “D” is most inferior.

A: Less than 1.0%
B: 1.0% or more and less than 1.25%
C: 1.25% or more and less than 3.0%
D: 3.0% or more

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Storage modulus | 2320 | 1429 | 1061 | 617 | 303 | 17.8 |
| [MPa/25° C., 1 × 10⁵ Hz] | | | | | | |
| Chipping resistance | A | A | B | C | C | D |

Evaluation results are shown in Table 1. The laminated glasses of Examples 1 to 3 having, as the interlayer film, a resin layer having a storage modulus of 1000 MPa or more at a temperature of 25° C. and a frequency of 1×10⁵ Hz exhibited specifically excellent chipping resistance as compared to the laminated glasses of Comparative Examples 1 to 3.

### REFERENCE SIGNS LIST

1: laminated glass, 2: film material for interlayer film of laminated glass, 5: interlayer film, 11, 12: glass plate, 21, 22: base film.

1. A laminated glass for a vehicle, comprising:
two facing glass plates; and
an interlayer film disposed between the two facing glass plates, wherein the interlayer film comprises a resin layer having a storage modulus of 1000 MPa or more at a temperature of 25° C. and a frequency of 1×10⁵ Hz.

2. The laminated glass according to claim 1, wherein the two facing glass plates comprise a first glass plate and a second glass plate that is thicker than the first glass plate, and wherein the resin layer is adjacent to the second glass plate.

3. The laminated glass according to claim 1, wherein the laminated glass is a windshield for an automobile.

4. The laminated glass according to claim 1, wherein the resin layer has a storage modulus of between 1000 MPa and 7000 MPa at the temperature of 25° C. and the frequency of 1×10⁵ Hz.

5. The laminated glass according to claim 1, wherein the resin layer has a storage modulus of between 1200 MPa MPa and 7000 MPa at the temperature of 25° C. and the frequency of 1×10⁵ Hz.

6. The laminated glass according to claim 1, wherein the resin layer comprises a thermoplastic resin.

7. The laminated glass according to claim 6, wherein the resin layer further comprises a plasticizer, and a content of the plasticizer in the resin layer is less than 18% by mass based on an amount of the thermoplastic resin.

8. The laminated glass according to claim 7, wherein the plasticizer consists of triethylene glycol di(2-ethylhexanoate).

9. The laminated glass according to claim 7, wherein the plasticizer consists of a single resin layer.

10. The laminated glass according to claim 1, wherein the two facing glass plates comprise a first glass plate and a second glass plate, and wherein the resin layer is located adjacent to and in contact with the second glass plate.

11. The laminated glass according to claim 10, wherein the second glass plate is thicker than the first glass plate, and wherein the resin layer is additionally located adjacent to and in contact with the first glass plate.
